(19) United States
(12) Patent Application Publication
(10) Pub. No.: US 2026/0104672 A1
(43) Pub. Date: Apr. 16, 2026

(54) TIMEPIECE DEVICE FOR DISPLAYING TIMEPIECE INFORMATION AND METHOD FOR OPERATING SAME

(71) Applicant: ROLEX SA, Geneva (CH)

(72) Inventor: Ludovic Zbylut, Seynod (FR)

(73) Assignee: ROLEX SA, Geneva (CH)

(21) Appl. No.: 19/355,074

(22) Filed: Oct. 10, 2025

(30) Foreign Application Priority Data
Oct. 15, 2024 (EP) 24206725.4

(51) Int. Cl. G04B 19/253

(52) U.S. Cl. CPC G04B 19/25333

(57) ABSTRACT

A method for operating a display device (100) for displaying timepiece information, in particular time information or time-related information, the device including a first display wheel (10) (i) comprising a first disk (11) presenting first timepiece information and a first edge provided with first portions (11b) and (ii) mounted so as to pivot about a first axis (A1), and a second component (21) comprising a second edge provided with a second portion (21b) having a configuration that is at least partially complementary to a configuration of a first portion (11b); the operating method including, during at least one display jump, a first step of displacement of the first axis (A1) making it possible to displace the first display wheel (10) relative to the second edge so as to move a first portion (11b) away from the second portion (21b), starting from a rest position of the first axis (A1), a display changing step, and a second step of displacement of the first axis (A1) making it possible to displace the first display wheel (10) relative to the second edge so as to move a first portion (11b) closer to the second portion (21b), up to the rest position of the first axis (A1).

### CROSS-REFERENCE TO RELATED APPLICATION

This application claims priority of European patent application No. EP24206725.4 filed Oct. 15, 2024, the content of which is hereby incorporated by reference herein in its entirety.

### FIELD OF THE INVENTION

The invention relates to a method for operating a device for displaying timepiece information, in particular a date displaying device. The invention also relates to a device for displaying timepiece information. The invention further relates to a timepiece movement comprising such a display device. It finally relates to a timepiece, in particular a wristwatch, comprising such a device or such a movement. The invention relates in particular to a display device or mechanism of the “big date” type, i.e. a date display using two disks, in particular a first disk indicating the units of the date and a second disk indicating the tens of the date.

### BACKGROUND ART

Document CH310559A describes a date of the “big date” type comprising two display disks juxtaposed in the same plane. The periphery of the disks is circular, thus resulting in a biconcave gap between the disks at the aperture.

Document EP0940833B1 discloses a solution for obtaining a date of the big date type with a rectilinear separation between the display of the ten and the unit of the date. This solution requires two display disks to be superposed in two distinct planes, thus requiring an additional thickness and generating an unsightly difference in height between the two numerals.

In document EP3779609B1, a date display of the “big date” type comprises two display disks that are truncated over approximately 60°, with the first disk having the numbers 4 to 18 and the second having the numbers 19 to 31, as well as 1 to 3. The disks are designed to be juxtaposed, and rotated in opposite directions without jamming by virtue of the truncated notches. Each disk is designed to be visible in turn through a single aperture. This solution requires larger display disks and/or a smaller font than a solution making use of two juxtaposed disks bearing the indications for the tens and units, respectively.

Date displays of the “big date” type make use of two juxtaposed disks that are generally displayed through an aperture separated into two parts. Generally, provision is made for a first part for displaying the tens and a second part for displaying the units. It is necessary to separate the aperture in order to hide the clearance or the unsightly gap in the shape of a biconcave lens that separates the two disks. This gap is due to the geometry of the periphery of the display disks, which is circular in order to allow them to rotate without mutual interference.

### SUMMARY OF THE INVENTION

The aim of the invention is to provide a device for displaying timepiece information, in particular time information or time-related information, in particular a date, that makes it possible to overcome the abovementioned drawbacks and improves the display devices known from the prior art. In particular, the invention proposes a device for displaying alternative timepiece information to known information, in particular clear information that has a high level of finishing in a one-piece aperture.

An operating method according to a first aspect of the invention is defined by point 1 below.
1. A method for operating a display device for displaying timepiece information, in particular time information or time-related information, the device comprising:
   a first display wheel (i) comprising a first disk presenting first timepiece information and a first edge provided with first portions and (ii) mounted so as to pivot about a first axis,
   a second component comprising a second edge provided with a second portion having a configuration that is at least partially complementary to a configuration of a first portion,
   the operating method comprising, during at least one display jump or during at least certain display jumps:
   a first step of displacement of the first axis making it possible to displace the first display wheel relative to the second edge so as to move a first portion away from the second portion, starting from a rest position of the first axis,
   a display changing step,
   a second step of displacement of the first axis making it possible to displace the first display wheel relative to the second edge so as to move a first portion closer to the second portion, up to the rest position of the first axis.

Various embodiments of the method are defined by points 2 to 5 below.
2. The operating method as defined in point 1, wherein the display changing step comprises rotating the first display wheel about the first axis.
3. The operating method as defined in point 1, wherein the display device comprises a second display wheel:
   comprising the second component consisting of a second disk presenting second timepiece information and the second edge provided with second portions, and
   mounted so as to pivot about a second axis, and
   wherein the display changing step comprises, during at least one display jump or during at least certain display jumps:
   rotating the second display wheel about the second axis, and/or
   rotating the first display wheel about the first axis.
4. The operating method as defined in one of the preceding points, wherein the first and second displacement steps are steps of displacement:
   in translation, and/or
   in rotation about a third axis, which is different from the first axis.
5. The operating method as defined in one of the preceding points, wherein the display jump is an instantaneous jump or a substantially instantaneous jump.

A display device according to a first aspect of the invention is defined by point 6 below.
6. A display device for displaying timepiece information, in particular time information or time-related information, the device comprising:
   a first display wheel (i) comprising a first disk presenting first timepiece information and a first edge provided with first portion, and (ii) mounted so as to pivot about a first axis,
   a second component comprising a second edge provided with a second portion having a configuration that is at least partially complementary to a configuration of a first portion, and
   actuating means arranged so that, during at least one display jump or during at least certain display jumps:
   they displace the first axis so as to displace the first display wheel relative to the second edge in order to move a first portion away from the second portion, starting from a rest position of the first axis,
   they change the display,
   they displace the first axis so as to displace the first display wheel relative to the second edge in order to move a first portion closer to the second portion, up to the rest position of the first axis.

Various embodiments of the display device are defined by points 7 to 15 below.
7. The display device as defined in the preceding point, wherein the actuating means are arranged so that they change the display by rotating the first display wheel about the first axis.
8. The display device as defined in point 6 or 7, wherein the device comprises a second display wheel:
   comprising the second component consisting of a second disk presenting second timepiece information and a second edge, and
   mounted so as to pivot about a second axis, and
   wherein the actuating means are arranged so that, during at least one display jump or during at least certain display jumps, they change the display:
   by rotating the second display wheel about the second axis, and/or
   by rotating the first display wheel about the first axis.
9. The display device as defined in the preceding point, wherein the first and second disks are coplanar.
10. The display device as defined in point 8 or 9, wherein the display device comprises a frame and wherein:
   the first display wheel is mounted so as to pivot about the first axis on the frame or on a first support that can move relative to the frame within a plane perpendicular to the first axis, and/or
   the second display wheel is mounted so as to pivot about the second axis on the frame or on a second support that can move relative to the frame within a plane perpendicular to the second axis.
11. The display device as defined in one of points 8 to 10, wherein the second piece of timepiece information is changed at a higher frequency than that at which the first piece of timepiece information, in particular a piece of timepiece information about the tens of the date, is changed.
12. The display device as defined in one of points 8 to 11, wherein the first disk is a disk displaying the tens of the dates and the second disk is a disk displaying the units of the dates.
13. The display device as defined in one of points 8 to 12, wherein the actuating means comprise:
   a control wheel,
   a drive wheel,
   a first movable support, and
   an indexing element for indexing the control wheel, such as a jumper,
   the control wheel comprising:
   a first set of teeth for driving the first display wheel,
   a second set of teeth for driving the second display wheel, and
   a third set of teeth for driving the control wheel.
14. The display device as defined in one of points 6 to 13, wherein the configurations of the first portion and of the second portion are respectively substantially:
   concave and convex, or
   convex and concave, or
   rectilinear and rectilinear.
15. The display device as defined in one of points 6 to 14, wherein it comprises an elastic return means urging the first portion and the second portion into contact with one another or into a configuration providing a clearance of less than 0.2 mm or less than 0.1 mm or less than 0.05 mm between the first portion and the second portion.

A movement according to the invention is defined by point 16 below.
16. A timepiece movement comprising a display device as defined in one of points 6 to 15.

A timepiece according to the invention is defined by point 17 below.
17. A timepiece, in particular a wristwatch, comprising:
   a timepiece movement as defined in the preceding point, and/or
   a display device as defined in one of points 6 to 15.

According to a second aspect of the invention, a display device 100 for displaying timepiece information, in particular time information or time-related information, the device comprises:
a first display wheel 10 (i) comprising a first disk 11 presenting first timepiece information and a first edge provided with first portions 11b, and (ii) mounted so as to pivot about a first axis A1, and
a second component comprising a second edge provided with a second portion 21b having a configuration that is at least partially complementary to a configuration of a first portion 11b,
actuating means 30, 40, 50, 52 for actuating at least the first display wheel,
the first portion 11b and the second portion 21b have complementary shapes,
the first wheel and the second component being arranged so that, in the stable state of displaying the timepiece information, a first portion 11b and a second portion 21b are:
in contact with one another, or
in a configuration providing a clearance of less than 0.2 mm or less than 0.1 mm or less than 0.05 mm between a first portion 11b and a second portion 21b.

### BRIEF DESCRIPTION OF THE DRAWINGS

The figures show, by way of example, an embodiment of a timepiece according to the invention.

FIG. 1 illustrates an embodiment of a timepiece according to the invention.

FIG. 2 illustrates a partial view of the display device of the embodiment of the timepiece according to the invention.

FIGS. 3 to 5 illustrate an operating sequence of the display device.

### DETAILED DESCRIPTION OF PARTICULAR EMBODIMENTS

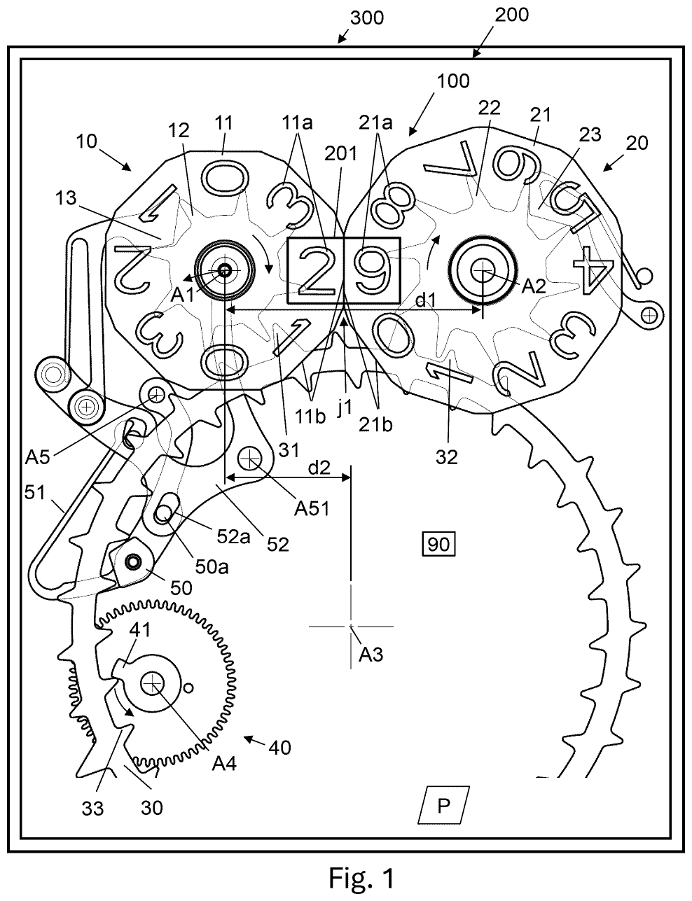

An embodiment of a timepiece 300 according to the invention is described below with reference to FIGS. 1 to 5. The timepiece is for example a watch, in particular a wristwatch. The timepiece comprises an embodiment of a timepiece movement 200 according to the invention. The timepiece movement comprises an embodiment of a device 100 for displaying timepiece information. The timepiece movement 200 may be:
a mechanical movement, in particular an automatic movement, or
an electronic movement, or
a hybrid movement.

The timepiece 300 also comprises a case intended to receive the timepiece movement 200 and to protect it from the external environment.

Preferably, the display device 100 makes it possible to display time information or time-related information, in particular a “big date” type information display within which the information is displayed by first and second disks provided in order to display the tens and units, respectively, of the information.

The display device 100 comprises a frame 90. This frame 90 may comprise a movement plate and/or a bridge. The display device 100 may consist of a module that can be assembled and can remain assembled independently of the rest of the movement. Once finished, this module may be fixed to the rest of the timepiece movement 200, in particular to a blank of the rest of the timepiece movement 200, such as a main plate. The frame 90 may be the frame of the timepiece movement 200.

The display device 100 for displaying timepiece information comprises:
a first display wheel 10:
   a) comprising a first disk 11 presenting first timepiece information and a first edge provided with first portions 11b, and
   b) mounted so as to pivot about a first axis A1,
a second edge provided with a second portion 21b having a configuration that is partially complementary to a configuration of a first portion, and
actuating means 30, 40, 50, 52 arranged so that, during at least certain display jumps or during at least one display jump:
   i) they displace the first axis A1 so as to displace the first display wheel 10 relative to the second edge in order to move a first portion 11b away from the second portion 21b, starting from a rest position of the axis A1,
   ii) they change the display,
   iii) they displace the first axis A1 so as to displace the first display wheel 10 relative to the second edge in order to move a first portion 11b closer to the second portion 21b, up to the rest position of the first axis A1.

Advantageously, the display device further comprises a second display wheel 20 comprising a second disk 21. The second disk 21 has second timepiece information and a second edge provided with second portions 21b. The second display wheel 20 is mounted so as to pivot about a second axis A2.

The actuating means 30, 40, 50, 52 are arranged so that, during at least one display jump or during at least certain display jumps, they change the display:
by rotating the second display wheel 20 about the second axis A2, and/or
by rotating the first display wheel 10 about the first axis A1.

In the embodiment described in detail and shown, the display device is a date displaying device of the “big date” type.

The first display wheel 10 further comprises a first pinion 12 secured to the first disk 11. The first disk 11 includes numerals 11a intended to indicate the tens of the date, in particular a series of numerals 0, 1, 2, 3 or a series of numerals 1, 2, 3 (in the latter case, an empty space or absence of marking on the disk is used instead of the numeral 0).

The second display wheel 20 comprises a second pinion 22 secured to the second disk 21. The second disk 21 includes numerals 21a intended to indicate the units of the date, i.e. a list of numerals from 0 to 9.

The first disk 11 may include, at least once, a sequence of the four numerals 11a of the tens, from 0 to 3 or from 1 to 3. The second disk 21 may include, at least once, a sequence of the ten numerals 21a of the units, from 0 to 9.

Preferably, the first and second disks 11, 21 are coplanar. Further preferably, the first and second disks 11, 21 are arranged side by side, so as to position a first piece of information, such as a numeral 11a of the tens of the first disk 11, and a second piece of information, such as a numeral 21a of the units of the second disk 21, next to one another in order to indicate the timepiece information, such as the date. The information is, for example, displayed through an aperture 201 of the dial, i.e. the information appears in the opening formed by the aperture.

The first and second axes A1 and A2 are preferably parallel.

Preferably, the two display wheels 10, 20 are respectively indexed by first and second jumpers 13, 23 cooperating with the first and second pinions 12, 22.

Preferably, the actuating means comprise:
a control wheel 30,
a drive wheel 40,
a first movable support 52, and
an indexing element 50 for indexing the control wheel 30, such as a jumper 50.

The first and second display wheels 10, 20 are driven by the control wheel 30. The control wheel 30 comprises:
a first set of teeth 31 for driving the first display wheel 10,
a second set of teeth 32 for driving the second display wheel 20, and
a third set of teeth 33 for driving the control wheel 30.

The first and second sets of teeth 31, 32 are respectively intended to cooperate with the first and second pinions 12, 22 of the display wheels 10, 20.

Each of these sets of teeth 31, 32 comprises truncated teeth, or teeth of different dimensions, arranged so as to enable the first disk 11 and the second disk 21 to be driven in a predetermined sequence.

In this case, in the embodiment described,
the first set of teeth 31 comprises 4 teeth that can cooperate with the first pinion 12, and
the second set of teeth 32 comprises 30 teeth that can cooperate with the second pinion 22.

The second set of teeth 32 is arranged in the same plane or at the same level as the first set of teeth 31. Certain teeth of the second set of teeth 32 coincide with or are inscribed in the first set of teeth 31, which comprises teeth of larger dimensions, with a larger pitch diameter than the second set of teeth.

The third set of teeth 33 makes it possible to drive the control wheel 30 using a finger 41 arranged within the drive wheel 40. Preferably, the driving is instantaneous or substantially instantaneous and is performed every 24 hours. In other words, the period of rotation of the drive wheel is 24 hours, so as to make it possible to drive the control wheel 30 by at least one step per day using a finger 41. In the embodiment described, the third set of teeth 33 comprises 31 teeth arranged in the same plane or at the same level as the first and second sets of teeth.

More generally, it should be emphasized that at least two of the three sets of teeth 31, 32, 33 of the control wheel 30 can coincide entirely or partially.

The control wheel 30 and the drive wheel 40 pivot within the frame 90, respectively about the axes A3 and A4, which are preferably parallel to the axis A1 and to the axis A2. Preferably, the control wheel 30 is indexed or substantially indexed by the indexing element 50 (hereinafter referred to as “jumper”) cooperating with the third set of teeth 33. The jumper 50 is also pivoted within the frame 90 about an axis A5 that is preferably parallel to the axis A1 and to the axis A2.

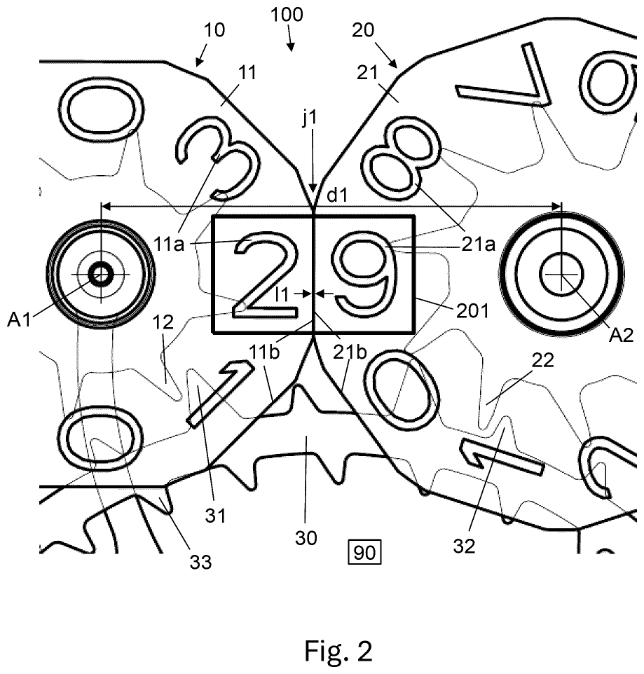

One particular feature of the solution according to the invention is that, at the aperture 201, the space or clearance between the outer edges of the disks 11, 21 does not have a gap in the shape of a biconcave lens, but has a gap j1 of constant width l1, as shown in FIG. 2. Preferably, the width of the gap is zero. Advantageously, the aperture 201 can therefore be devoid of a partition separating the display of the tens and the units.

To this end, the outer edge or periphery of the first disk 11, next to each numeral 11a of the tens, comprises portions 11b that can closely follow the shape of complementary portions 21b on the outer edge or periphery of the second disk 21, next to each numeral 21a of the units, and vice versa. In other words, the shapes selected for the outer peripheries of the two disks 11, 21 are designed so as to have portions 11b, 21b that are complementary or the shapes of which can closely follow one another, in particular at the aperture 201. One of the disks 11, 21, or the disks 11, 21 therefore advantageously do not have a circular outer periphery or edge.

In this case, the outer edge or periphery of the disks 11, 21 of the embodiment described and shown comprises rectilinear portions 11b, 21b adjacent to each piece of information 11a, 21a. The rectilinear portions 11b, 21b are preferably oriented in an orthoradial direction relative to the axes A1, A2, as shown in FIG. 2. In this way, when they are positioned facing the aperture 201, the gap j1 between each rectilinear portion 11b, 21b forms a space with a width l1 that is constant, preferably of zero. More particularly, the gap j1 has a rectilinear or substantially rectilinear geometry with a constant or zero width.

In order for the gap j1 to have a width of zero, substantially zero or tending toward 0, the two disks 11, 21 advantageously radially bear or substantially bear against one another. To this end, at least one of the two display wheels 10, 20, in this case the first 10, is advantageously pivoted on a first movable support 52 (in particular a lever 52), which is itself pivoted within the frame 90 about an axis A51, which is different from the first axis A1. The axis A51 is, for example, parallel to the axis A1 (and remote from the axis A1) and perpendicular to the disks 10 and 11. The second display wheel 20 is pivoted, for example, within the frame 90. In other words, the axis A2 is fixed relative to this frame. The lever 52 is intended to allow the first display wheel 10 to be displaced, in particular within a plane P perpendicular to the axis A1, during at least one driving phase of the control wheel 30. This displacement is essential, in at least one driving phase, for driving one and/or the other of the two disks 11, 21 in rotation, because, on account of their non-circular edges or peripheries arranged with a small clearance, the rotation necessarily generates interference, unless the center-to-center spacing d1 between the two display wheels 10 and 20 is increased.

The first jumper 13 is preferably arranged within the lever 52. The second jumper 23 is preferably arranged within the frame 90.

The lever 52 cooperates directly or indirectly with the third set of teeth 33 of the control wheel 30 so as to be set in motion during each phase of driving the display. In other words, for each step taken or for each tooth passage, the set of teeth 33 displaces the lever 52 in a back-and-forth movement. These kinematics are explained in more detail below. In the embodiment described and shown, the lever 52 is set in motion by means of the third jumper 50, which actuates the latter by means of a portion 50a that cooperates with a complementary portion 52a formed on the lever 52 as shown in FIG. 1. More particularly, the portion 50a is a pin or a stud 50a, and the complementary portion 52a is a slideway or an oblong opening 52a. Thus, when the third jumper 50 is set in motion by being driven by the control wheel 30, it actuates the lever 52 so as to momentarily displace the first axis A1 and the first display wheel 10 within the plane P and increase the center-to-center spacing d1 between the display wheels 10, 20, i.e. between the axes A1 and A2. Alternatively, the lever 52 and the jumper 50 can therefore be the same component, which would pivot within the frame 90 about an axis A5 or A51.

The lever 52 is urged into its rest position by an elastic return element 51 which, in the embodiment described and shown, is included in the third jumper 50. Furthermore, outside the driving phases, the elastic return element 51 also makes it possible to hold the first disk 11 against the second disk 21, so as to have a gap j1 with a width l1, for example of zero or substantially zero.

At rest, in order to optimally control the width l1 of the gap j1, it is preferable for the third jumper 50 to position the control wheel 30 with a slight clearance, so as to guarantee that the first display wheel 10 is correctly positioned relative to the second display wheel 20, under the effect of the elastic return element 51. In this case, this makes it possible to guarantee that, at rest, a first portion 11b of the first display wheel 10 bears correctly against a second portion 21b of the second display wheel 20. Alternatively, this makes it possible to guarantee that, at rest, the lever bears correctly against a stop and, consequently, to control the width l1 of the gap j1.

One embodiment of an operating method according to the invention is described below. Such an embodiment is, for example, a way of operating the display device or the timepiece movement or the timepiece, which are described above.

The operating method comprises, during at least one display jump or during at least certain display jumps:
a first step of displacement of the first axis A1 making it possible to displace the first display wheel 10 relative to the second edge so as to move a first portion 11b away from the second portion 21b, starting from a rest position of the first axis A1,
a display changing step,
a second step of displacement of the first axis A1 making it possible to displace the first display wheel 10 relative to the second edge so as to move a first portion 11b closer to the second portion 21b, up to the rest position of the first axis A1.

In the embodiment described and shown, all of the (three) steps mentioned in the preceding paragraph are implemented for each display jump. These three steps mentioned in the preceding paragraph form part of the driving phase already mentioned above.

During the driving phase, the first and second display wheels 10, 20 can be driven in rotation by the first and second sets of teeth 31, 32, respectively, of the control wheel 30 in order to change the timepiece information displayed by the first and second display disks. The control wheel 30 is driven by the drive wheel 40 by means of the finger 41 cooperating with the third set of teeth 33.

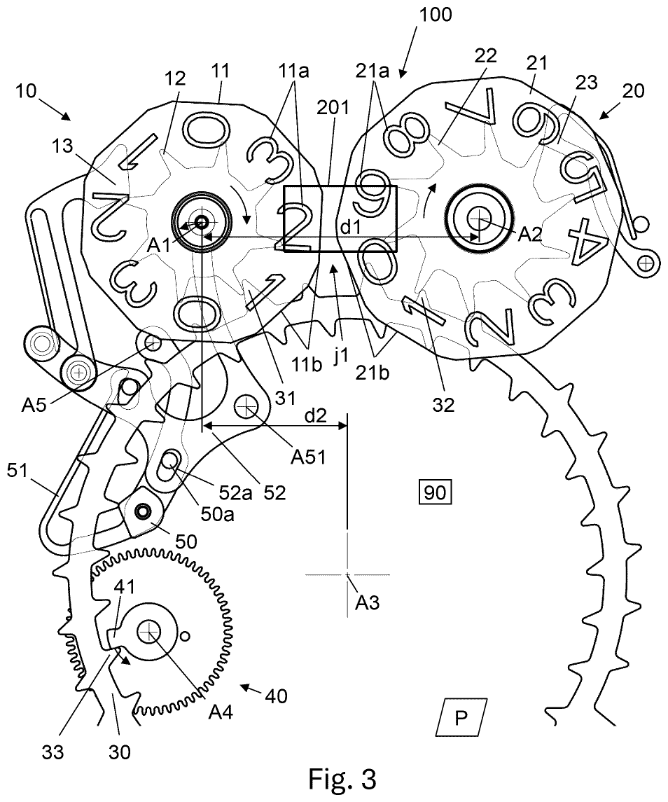

Simultaneously or substantially simultaneously, when the control wheel 30 is set in motion by means of the finger 41 cooperating with the set of teeth 33, the latter lifts the jumper 50, thereby causing the first axis A1 and the first display wheel 10 to be displaced within the plane P, so as to increase the center-to-center spacing d1 between the two display disks 11, 21. More particularly, in the embodiment described and shown, the stud 50a of the jumper 50 acts against the oblong opening 52a of the lever 52 so as to cause it to pivot about its axis A51 and to displace the first display wheel 10 within the plane P. In this way, the increase in the center-to-center spacing d1 allows the display wheels 10, 20 to rotate without touching one another during the display changing step, despite the fact that the disks 11, 21 have non-circular peripheries, as illustrated in FIG. 3.

When the jumper 50 has passed the top of the tooth of the set of teeth 33, it is urged toward the bottom of the set of teeth by the elastic return element 51, consequently initiating the displacement of the lever 52 toward its rest position.

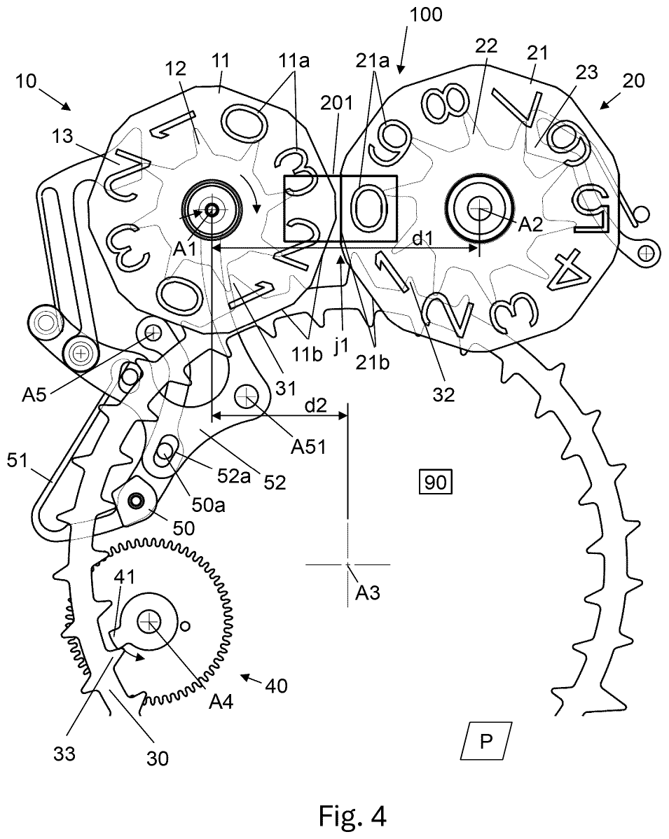

Under the action of the first jumper 13, as soon as it has passed the top of the tooth of the set of teeth 12, the first display wheel 10 completes its rotation so as to be indexed to the subsequent numeral 11a as illustrated in FIG. 4. Preferably, the rotation of the first display wheel 10 must be completed before the lever 52 returns to its rest position.

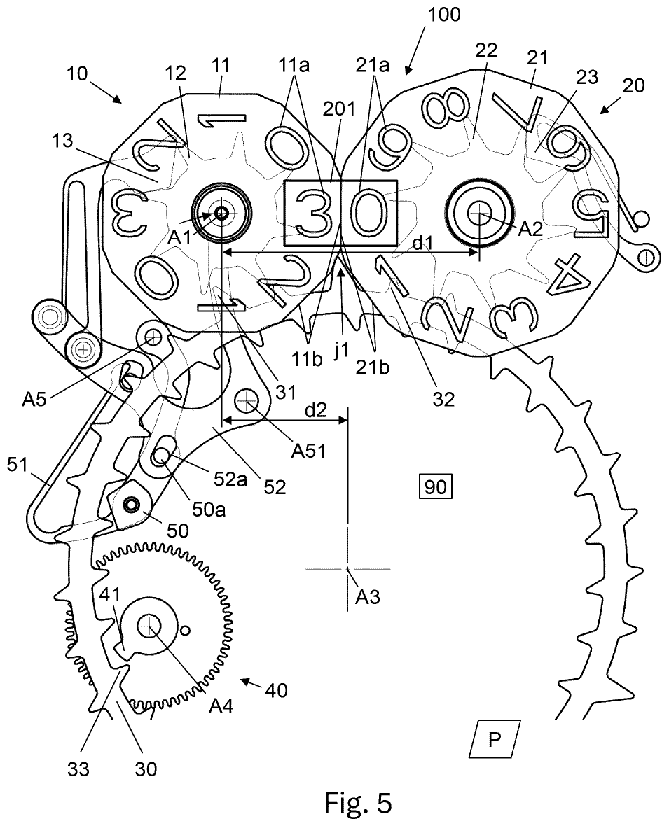

In the same way, the second display wheel 20 completes its rotation under the effect of the second jumper 23 so as to be indexed to the subsequent numeral 21a. At the end of the driving phase, the first disk 11 is once again against or substantially against the second disk 21 under the effect of the elastic element 51, and it is indexed by the first jumper 13 as illustrated in FIG. 5.

Thus, preferably, the first displacement step comprises a first displacement of the first axis A1 starting from its rest position and the second displacement step comprises a second displacement of the first axis A1 as far as its rest position.

The display changing step makes it possible to position facing one another (in order to indicate a subsequent piece of timepiece information), at a first time, portions 11b, 21b that are different from the first portion 11b and/or from the second portion 21b that have been positioned facing one another, at a preceding time, prior to the changing step. In other words, when the first display wheel 10 or the second display wheel 20 is respectively indexed to or positioned at the subsequent numeral 11a, 21a (in order to indicate the subsequent piece of timepiece information), the subsequent portion 11b, 21b is positioned within the aperture 201.

It should be emphasized that, in the embodiment described and shown, preferably in the case in which one of the two display wheels 10, 20 is not driven in rotation by the control wheel 30, for example during the passage from 30 to 31 or from 31 to 1^{st}, the first wheel is nevertheless displaced within the plane P during the driving phase, in order to enable the date to be changed without the disks 11, 21 interfering. In other words, for each driving phase, the lever 52 is actuated in the same way as before. However, the first set of teeth 31 or the second set of teeth 32 do not systematically cooperate with the first pinion 12 or the second pinion 22, respectively.

As a consequence of what has been described above, the display changing step advantageously comprises rotating the first display wheel 10 about the first axis A1 and/or rotating the second display wheel 20 about the second axis A2.

In the embodiment described above and shown, the first display wheel is displaced relative to the frame 90 and the second display wheel remains fixed relative to the frame (besides rotating about its axis A2). Alternatively, regardless of the embodiment or variant, the second display wheel may be displaced relative to the frame 90 and the first display wheel may remain fixed relative to the frame (besides rotating about its axis A1). Alternatively again, regardless of the embodiment or variant, the second display wheel may be displaced relative to the frame 90 and the first display wheel may be displaced relative to the frame 90. Preferably, these displacements of the wheels are carried out within the plane P. In the case of the last two alternatives, the second display wheel is mounted so as to be pivoted on a second support that can be displaced relative to the frame 90, the second support being different from any first support. The second support can preferably be displaced perpendicular to the axis A2.

In the embodiment described above and shown, the support 52 is urged into a rest position by an elastic element 51. Alternatively, regardless of the embodiment or variant, the support 52 can be actuated by the control wheel 30 by means of a positive-drive connection.

In the embodiment described above and shown, the portions 11b, 21b, which are visible in stable positions of the display disks in the aperture, are rectilinear. Alternatively, regardless of the embodiment or variant, the portions 11b, 21b that are visible in stable positions of the display disks in the aperture may have any complementary geometries. These geometries may in particular be curved, in particular convex or concave. They may also comprise convex regions and concave regions. The portions 11b, 21b may have zig-zag or undulating geometries. In particular, the second display disk may have a circular edge or periphery and the first display disk 11 may have portions 11b that are visible in stable positions of the display disks in the aperture and are concave and complementary to the curvature of the periphery of the second disk. In this case, the second disk makes it possible, for example, to display the units of the timepiece information, in particular the units of the dates. With such a configuration, the support does not necessarily have to be displaced during display jumps that result only in the second wheel 20 being rotated and the support is advantageously displaced only during display jumps that result in the first wheel 10 being rotated. In the case of a date display, the support would be displaced only when the display of the tens of the date is changed. Alternatively, the first display disk may have a circular edge or periphery and the second display disk 12 may have portions 12b that are visible in stable positions of the display disks in the aperture and are concave and complementary to the curvature of the periphery of the first disk. With such a configuration, the support does not necessarily have to be displaced during display jumps that result only in the first wheel 10 being rotated and the support is advantageously displaced only during display jumps that result in the second wheel 20 being rotated.

Preferably, it is possible to use:
one disk having a circular periphery to display one part of the information, in particular the units of a number, in particular the units of a date, said part being changed at a first frequency, and
another disk having a periphery with portions of complementary geometry to the circular periphery to display another part of the information, in particular the tens of a number, in particular the tens of a date, said other part being changed at a second frequency, the first frequency being higher than the second.

More generally, the solution according to the invention can be adapted so as to have, in the aperture, a gap j1 between the first and second disks that is:
not necessarily rectilinear, and/or
with a constant or non-constant and/or non-zero width l1, and/or
with a zero or non-zero width l1.

In summary and as a result of the solutions according to the invention, it is possible to define a gap geometry freely and without restriction. Thus, the visible portions 11b and 21b may have rectilinear or curved shapes. Preferably, these portions are parallel (in stable display states), i.e. the distance (measured perpendicular to the tangents to the edges) between the portions 11b and 21b is constant.

Regardless of the embodiment or variant, the clearance (or the width l1) is less than 0.2 mm or less than 0.1 mm or less than 0.05 mm. Thus, the first and second wheels are advantageously arranged so that, in a stable state of displaying the timepiece information, a first portion 11b and a second portion 21b are:
in contact with one another, or
in a configuration providing a clearance of less than 0.2 mm or less than 0.1 mm or less than 0.05 mm between a first portion 11b and a second portion 21b.

The solution according to the invention is not limited to displaying a date, but could be used for any information that can be displayed by disks, for example the year, the month, the day of the week, a number of hours, a number of minutes or more generally any numeric or alphanumeric display using jumping numerals or characters.

The combination of disks could also be used to display a Moon phase. In this example, each disk could form a part of the display, in particular half of the display of the Moon. More particularly, a first disk would include a first part of the display of the various phases of the Moon, and a second disk would include a second part, complementary to the first part, of the display of the various phases of the Moon. More generally, the combination of the disks could also be used to display particular geometries, symbols, or even emojis.

Alternatively, in a variant (not illustrated) in which just one display wheel is required for displaying information, the second portion 21b may form part of a second edge of a frame or of a fixed border of a second component, such as a second edge of a dial, of an aperture, of a flange or of a blank.

As an alternative to the embodiment described and shown, one or more intermediate wheels may be arranged between the control wheel 30 and the pinion 12 and/or the pinion 22 and/or the drive wheel 40.

In the embodiment described above and shown, the support 52 is actuated by the control wheel 30 in order to increase the center-to-center spacing d1 between the disks 11, 21. Alternatively, regardless of the embodiment or variant, it is not essential for the support 52 to be actuated by the control wheel 30 in order to increase the center-to-center spacing d1 between the disks 11, 21. Specifically, the support can simply be shifted or displaced by the reaction of one disk on the other during their rotation or during its rotation. Alternatively or additionally, the displacement of the movable support bearing a display wheel may be displaced under the mechanical action of the set of teeth 31 on the set of teeth 12.

The jumps take place at a frequency defined on the basis of the timepiece information to be displayed, typically every 24 hours for date information or day information.

In the embodiment described above and shown, the steps of displacement by moving away and moving closer are steps of displacement in rotation about a third axis A51, in particular in rotation about a third axis A51, which is remote from the first axis A1 and from the second axis A2. However, alternatively, regardless of the embodiment or variant, the steps of displacement by moving away and moving closer may be steps of displacement in translation. In such a case, the lever 52 could be replaced by a support of the slide type that can move in translation relative to the frame 90 and on which the first wheel 10 would be pivoted.

Preferably, regardless of the embodiment or variant, the steps of displacement by moving away, of changing the display and of displacement by moving closer are performed one after the other.

Alternatively:
the step of changing the display can be implemented while the step of displacement by moving away has already started and has not been completed, and/or
the step of displacement by moving closer can be implemented while the step of changing the display has already started and has not been completed, the step of changing the display, however, ending before the step of displacement by moving closer has been completed.

Preferably, regardless of the embodiment or variant,
the first set of teeth 31 forms part of the second set of teeth 32, and/or
the first set of teeth 31 and the second set of teeth 32 are formed at the same level, and/or
one of the first set of teeth 31 and second set of teeth 32, on the one hand, and the third set of teeth 33, on the other hand, are formed at the same level.

Preferably, regardless of the embodiment or variant, the jumps are instantaneous or substantially instantaneous jumps. Preferably, throughout this application, “instantaneous jump” is understood to mean a jump lasting a few fractions of a second, typically of the order of approximately one hundredth of a second or approximately one twenty-fifth of a second or even approximately one tenth of a second. Preferably, throughout this application, “substantially instantaneous” is understood to mean a jump lasting of the order of a few seconds, for example between 1 second and 10 seconds.

Thus, according to the invention, there is a great freedom of definition of:
the geometry of the periphery of the display disks, and/or
the clearance between these disks at the aperture (which may optionally be eliminated).

The solutions according to the invention make it possible to make use of two juxtaposed display disks while offering great freedom as to the definition of the geometry of the periphery of the disks while limiting the clearance or the gap between the latter. More particularly, these solutions make it possible to obtain a rectilinear gap with a width that may be zero. In this way, it is advantageously possible to implement an aperture with a single opening, without separation, for displaying the date, as opposed to an aperture with two openings for displaying the tens in one opening and the units in another opening.

Finally, the solutions according to the invention do not require more space than the solutions known from the prior art, in particular at the disks.

1. A method for operating a display device for displaying timepiece information, the device comprising:
a first display wheel comprising a first disk presenting first timepiece information and a first edge provided with first portions, the first display wheel being mounted so as to pivot about a first axis, and
a second component comprising a second edge provided with a second portion having a configuration at least partially complementary to a configuration of a first portion,
the method comprising, during at least one display jump or during at least certain display jumps:
performing a first displacement of the first axis making it possible to displace the first display wheel relative to the second edge so as to move a first portion among the first portions away from the second portion, starting from a rest position of the first axis,
changing the display, and
performing a second displacement of the first axis making it possible to displace the first display wheel relative to the second edge so as to move a first portion among the first portions closer to the second portion, up to the rest position of the first axis.

2. The method as claimed in claim 1, wherein the changing of the display comprises rotating the first display wheel about the first axis.

3. The method as claimed in claim 1,
wherein the display device comprises a second display wheel:
comprising the second component consisting of a second disk presenting second timepiece information and the second edge provided with second portions, and
mounted so as to pivot about a second axis, and
wherein the changing of the display comprises, during at least one display jump or during at least certain display jumps:
rotating the second display wheel about the second axis, and/or
rotating the first display wheel about the first axis.

4. The method as claimed in claim 1, wherein the first and second displacements include displacements:
in translation, and/or
in rotation about a third axis, the third axis being different from the first axis.

5. The method as claimed in claim 1, wherein the display jump is an instantaneous jump or a substantially instantaneous jump.

6. A display device for displaying timepiece information, the device comprising:
a first display wheel comprising a first disk presenting first timepiece information and a first edge provided with first portions, the first display wheel being mounted so as to pivot about a first axis,
a second component comprising a second edge provided with a second portion having a configuration that is at least partially complementary to a configuration of a first portion among the first portions, and
actuating means arranged so that, during at least one display jump or during at least certain display jumps:
the actuating means displace the first axis so as to displace the first display wheel relative to the second edge in order to move a first portion among the first portions away from the second portion, starting from a rest position of the first axis,
the actuating means change the display, and
the actuating means displace the first axis so as to displace the first display wheel relative to the second edge in order to move a first portion among the first portions closer to the second portion, up to the rest position of the first axis.

7. The display device as claimed in claim 6, wherein the actuating means are arranged so that the actuating means change the display by rotating the first display wheel about the first axis.

8. The display device as claimed in claim 6,
wherein the device comprises a second display wheel:
comprising the second component consisting of a second disk presenting second timepiece information and a second edge, and
mounted so as to pivot about a second axis, and
wherein the actuating means are arranged so that, during at least one display jump or during at least certain display jumps, the actuating means change the display:
by rotating the second display wheel about the second axis, and/or
by rotating the first display wheel about the first axis.

9. The display device as claimed in claim 8, wherein the first and second disks are coplanar.

10. The display device as claimed in claim 8,
wherein the display device comprises a frame
and wherein:
the first display wheel is mounted so as to pivot about the first axis on the frame or on a first support that can move relative to the frame within a plane perpendicular to the first axis, and/or
the second display wheel is mounted so as to pivot about the second axis on the frame or on a second support that can move relative to the frame within a plane perpendicular to the second axis.

11. The display device as claimed in claim 8, wherein the second piece of timepiece information is changed at a higher frequency than a frequency at which the first piece of timepiece information is changed.

12. The display device as claimed in claim 8, wherein the first disk is a disk displaying tens of dates and the second disk is a disk displaying units of dates.

13. The display device as claimed in claim 8, wherein the actuating means comprise:
a control wheel,
a drive wheel,
a first movable support, and
an indexing element for indexing the control wheel
the control wheel comprising:
a first set of teeth for driving the first display wheel,
a second set of teeth for driving the second display wheel, and
a third set of teeth for driving the control wheel.

14. The display device as claimed in claim 6, wherein the configurations of the first portion and of the second portion are respectively substantially:
concave and convex, or
convex and concave, or
rectilinear and rectilinear.

15. The display device as claimed in claim 6, wherein the display device comprises an elastic return means urging the first portion the second portion into contact with one another or into a configuration providing a clearance of less than 0.2 mm between the first portion and the second portion.

16. A timepiece movement comprising the display device as claimed in claim 6.

17. A timepiece
comprising the timepiece movement as claimed in claim 16.

18. The display device as claimed in claim 11, wherein the first piece of timepiece information is a piece of timepiece information about tens of date.

19. The display device as claimed in claim 6, wherein the display device comprises an elastic return means urging the first portion the second portion into a configuration providing a clearance of less than 0.1 mm between the first portion and the second portion.

20. The display device as claimed in claim 6, wherein the display device comprises an elastic return means urging the first portion the second portion into a configuration providing a clearance of less than 0.05 mm between the first portion and the second portion.
